(19) United States
(12) Patent Application Publication
(10) Pub. No.: US 2019/0300212 A1
(43) Pub. Date: Oct. 3, 2019

(54) ROBOT AND METHOD OF OPERATING THE SAME

(71) Applicant: KAWASAKI JUKOGYO KABUSHIKI KAISHA, Kobe-shi, Hyogo (JP)

(72) Inventors: Yasuhiko HASHIMOTO, Kobe-shi (JP); Kenji BANDO, Nishinomiya-shi (JP); Kazunori HIRATA, Yao-shi (JP)

(73) Assignee: KAWASAKI JUKOGYO KABUSHIKI KAISHA, Kobe-shi, Hyogo (JP)

(21) Appl. No.: 16/468,819

(22) PCT Filed: Dec. 7, 2017
(86) PCT No.: PCT/JP2017/043976

§ 371 Date: Jun. 12, 2019

(30) Foreign Application Priority Data
Dec. 13, 2016 (JP) 2016-241521

(51) Int. Cl. B65B 5/12; B65B 5/10; B25J 9/00; B25J 11/00

(52) U.S. Cl. CPC B65B 5/12; B25J 11/0045; B25J 9/0084; B65B 5/105

(57) ABSTRACT

A robot is a robot configured to pack food in a container, and includes a first arm configured to move a plate-shaped part, a second arm configured to move a cylindrical part having a top opening and a bottom opening, and a control device. The control device operates the first arm and the second arm so that the cylindrical part and the plate-shaped part are moved above the container, while covering by the plate-shaped part the bottom opening of the cylindrical part where the food is accommodated, and the plate-shaped part is moved over the container to open the bottom opening.

### TECHNICAL FIELD

The present disclosure relates to a robot and a method of operating the same.

### BACKGROUND ART

For example, a food dish-up robot of Patent Document 1 is known as a device which packs food in a container. This robot grips a container for food conveyance where food is accommodated, carries the food above a container for dish up, and then dishes up in the container for dish up the food accommodated in the container for food conveyance. This container for food conveyance has a bottom plate pulled by a spring, and the bottom plate is closed when the food is accommodated. When dishing up the food, the robot causes the plunger to push a hook attached to the bottom plate, and opens the bottom plate by overcoming the pulling force of the spring to drop the food.

### REFERENCE DOCUMENT OF CONVENTIONAL ART

### Patent Document

[Patent Document 1] JP2003-128002A

### DESCRIPTION OF THE DISCLOSURE

### Problems to be Solved by the Disclosure

When opening the bottom plate of the container for food conveyance in Patent Document 1, since the bottom plate inclines downwardly, the container for food conveyance cannot be brought close to the container for dish up. Therefore, it is difficult to dish up the food at a desirable position in the container for dish up.

Moreover, since a plurality of parts, such as the bottom plate, the spring, and the hook, are attached to the container for food conveyance, the food tends to be built up at these parts. In addition, it is difficult to clean the container for food conveyance having the complicated shape. Therefore, it tends to cause a sanitary problem.

The present disclosure is made in view of solving the conventional problems, and one purpose thereof is to provide a robot and a method of operating the same, which is sanitary and is capable of dishing up food at a desired position.

### SUMMARY OF THE DISCLOSURE

In order to solve the conventional problem, a robot according to one aspect of the present disclosure is a robot configured to pack food in a container, and includes a first arm configured to move a plate-shaped part, a second arm configured to move a cylindrical part having a top opening and a bottom opening, and a control device. The control device operates the first arm and the second arm so that the cylindrical part and the plate-shaped part are moved above the container, while covering by the plate-shaped part the bottom opening of the cylindrical part where the food is accommodated, and the plate-shaped part is moved over the container to open the bottom opening.

According to this configuration, by the plate-shape part being slid, it is not necessary to take a large distance between the container and the cylindrical part in order to open the bottom opening, and the cylindrical part can be brought closer to the container when opening the bottom opening. Thus, the food can be dished up from the cylindrical part located closer thereto at the desirable position in the container. In addition, since a member for opening the bottom opening is not attached to the cylindrical part and the plate-shape part, the cylindrical part and the plate-shape part become simpler. Thus, the food is not built up at these parts as well as it is easy to clean them, and these parts can be kept sanitary.

In the robot, the control device may operate the first arm so that the food accommodated in the container is brought to one side by the plate-shaped part. According to this configuration, by bringing the food to one side in the container, the thickness and density of the food can be uniform and a given amount of food can be scooped up from the container.

In the robot, the control device may operate the first arm so that the food accommodated in the container is scooped up by the plate-shaped part and is inserted through the top opening into the cylindrical part placed on a placing surface. According to this configuration, the plate-shaped part can be functioned as a bottom which closes the bottom opening of the cylindrical part and also as a spatula which puts the food into the container, which leads to a reduction of the number of components and the cost.

The control device may operate the first arm so that one end of the plate-shaped part is brought in contact with a top edge of the cylindrical part where the food is accommodated and is slid on the top edge to remove the food above the top edge. According to this configuration, by removing the food jutted out of the cylindrical part, a given amount of food can be contained in the cylindrical part.

The robot may further include a depressing part provided to the first arm, and the control device may operate the first arm so that the food accommodated in the cylindrical part of which the bottom opening is opened is depressed by the depressing part. According to this configuration, the food which adheres to the cylindrical part, such as rice, may not fall from the cylindrical part only by opening the bottom opening of the cylindrical part. In such a case, by depressing the food inside the cylindrical part by the depressing part, the food can be dropped from the cylindrical part, and dished up in the container.

The robot may further include a grip part provided to the second arm, and a to-be-gripped part provided to the cylindrical part. The control device may operate the second arm so that the cylindrical part is moved by the grip part gripping the to-be-gripped part. According to this configuration, a plurality of cylindrical parts having different sizes, shapes, etc. may be prepared and the cylindrical part is selected according to the food. By gripping the to-be-gripped part of this cylindrical part by the grip part, the cylindrical part can suitably be used differently.

A method of operating a robot according to another aspect of the present disclosure is a method of operating a robot configured to pack food in a container. The robot includes a first arm configured to move a plate-shaped part, a second arm configured to move a cylindrical part having a top opening and a bottom opening, and a control device. The control device operates the first arm and the second arm so that the cylindrical part and the plate-shaped part are moved above the container, while covering by the plate-shaped part the bottom opening of the cylindrical part where the food is accommodated, and the plate-shaped part is moved over the container to open the bottom opening. According to this method, since the cylindrical part can be brought closer to the container, the food can be dished up from the cylindrical part at the desirable position in the container. In addition, since the cylindrical part and the plate-shape part become simpler, the food is not built up and it is easy to clean, and these parts can be kept sanitary.

### Effect of the Disclosure

The present disclosure has the configuration described above and has the effect of providing a sanitary robot and a method of operating the same which can dish up the food at the desired position.

### BRIEF DESCRIPTION OF DRAWINGS

FIG. 1 is a schematic view illustrating an outline configuration of a robot according to Embodiment 1 of the present disclosure.

FIG. 2 is a functional block diagram schematically illustrating a configuration of a robot control device illustrated in FIG. 1.

FIG. 3 is a perspective view illustrating a state where food inside a container is brought to one side by a flat-plate part illustrated in FIG. 1.

FIG. 4 is a perspective view illustrating a state where the food is scooped by the flat-plate part illustrated in FIG. 3.

FIG. 5 is a perspective view illustrating a state where the food is inserted into a cylindrical part by the flat-plate part illustrated in FIG. 4.

FIG. 6 is a perspective view illustrating a state where the food jutted out of the cylindrical part is removed by the flat-plate part illustrated in FIG. 5.

FIG. 7 is a perspective view illustrating a state where the flat-plate part illustrated in FIG. 6 carries the food, while closing a bottom opening of the cylindrical part.

FIG. 8 is a perspective view illustrating a state where the flat-plate part illustrated in FIG. 7 is removed from the bottom opening of the cylindrical part to open the bottom opening.

FIG. 9 is a perspective view illustrating a state where the food inside the cylindrical part illustrated in FIG. 8 is depressed by a depressing part.

FIG. 10 is a perspective view illustrating a robot according to Embodiment 2 of the present disclosure.

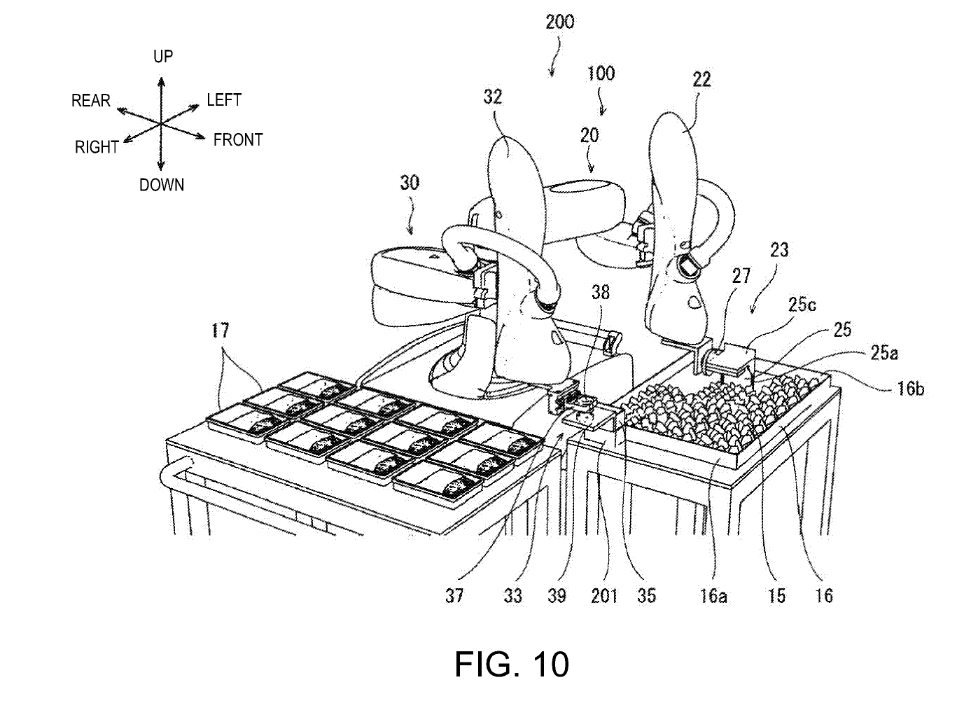

### MODES FOR CARRYING OUT THE DISCLOSURE

Hereinafter, embodiments of the present disclosure will be described with reference to the drawings. Note that, throughout the drawings, the same reference characters are given to the same or corresponding parts to omit redundant description. Moreover, throughout the drawings, components illustrating the present disclosure are selectively illustrated, and illustration of other components may be omitted. Further, the present disclosure is not limited to the following embodiments.

### Embodiment 1

### [Configuration of Robot]

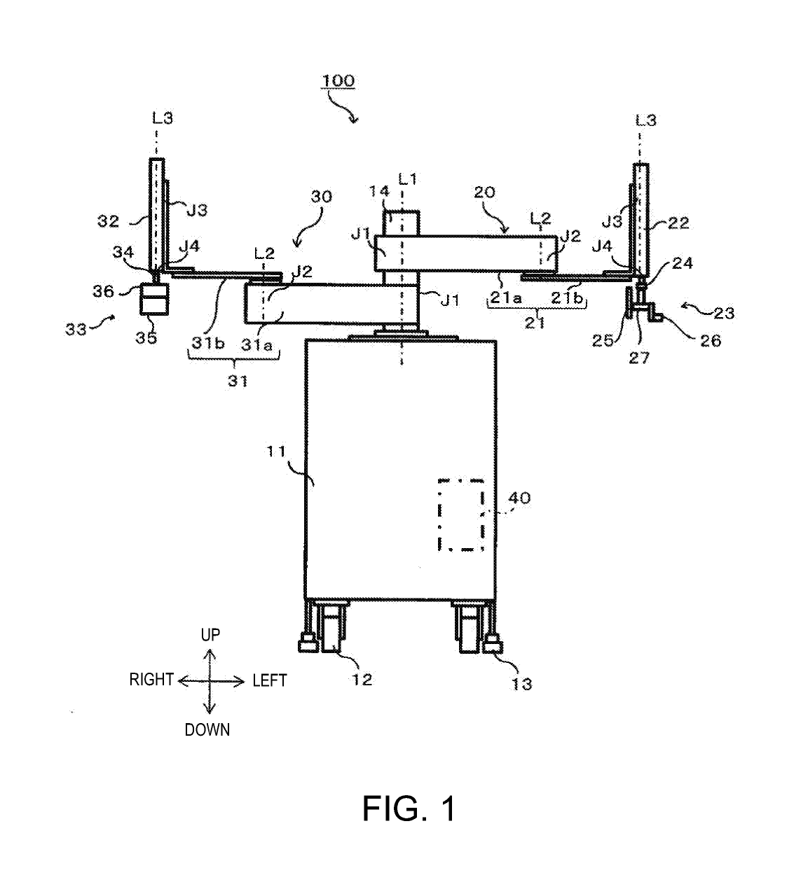

As illustrated in FIG. 1, the robot 100 according to Embodiment 1 is a robot 100 which packs food in a container, and includes a first arm 20, a second arm 30, and a control device 40. For example, a horizontal articulated robot is used as the robot 100. However, the robot 100 is not limited to this configuration, and may be other robots, such as a vertical articulated robot.

The robot 100 is provided with a carrier 11, and wheels 12 and fixing parts 13 are provided to a bottom surface of the carrier 11. The robot 100 is configured to be movable by the wheels 12, and fixed on the floor by the fixing parts 13. The control device 40 is accommodated in the carrier 11.

Moreover, a base shaft 14 is fixed to an upper surface of the carrier 11. The first arm 20 and the second arm 30 are provided to the base shaft 14 so as to be rotatable about a rotation axis L1 passing through the axial center of the base shaft 14. The first arm 20 and the second arm 30 are provided with a height difference therebetween. Note that the first arm 20 and the second arm 30 are configured to be operable independently or dependently.

The first arm 20 includes a first arm part 21, a first wrist part 22, and a first hand part 23. The second arm 30 includes a second arm part 31, a second wrist part 32, and a second hand part 33. Note that, although the first arm 20 and the second arm 30 have substantially the same configuration, except for the first hand part 23 and the second hand part 33, they are not limited to this structure. For example, the arm parts 21 and 31 and the wrist parts 22 and 32 may be different between the first arm 20 and the second arm 30.

The first arm part 21 is comprised of a #1a link 21a and a #1b link 21b each having a substantially rectangular parallelepiped shape, and the second arm part 31 is comprised of a #2a link 31a and a #2b link 31b each having a substantially rectangular parallelepiped shape. Each of the links 21a and 31a is provided at a base-end part with a rotary joint J1, and provided at a tip-end part with a rotary joint J2. Each of the links 21a and 31a is coupled at the base-end part to the base shaft 14 through the rotary joint J1, and is rotatable about the rotation axis L1 by the rotary joint J1.

The links 21b and 31b are coupled at base-end parts to the tip-end parts of the respective links 21a and 31a through the rotary joints J2, and are rotatable about rotation axes L2 by the rotary joints J2. Each of the links 21b and 31b is provided at a tip-end part with a linear-motion joint J3.

The wrist parts 22 and 32 are coupled to the tip-end parts of the respective links 21b and 31b through the linear-motion joints J3, and are ascendable and descendable with respect to the respective links 21b and 31b. Lower end parts of the wrist parts 22 and 32 are provided with rotary joints J4, and lower end parts of the rotary joints J4 are provided with respective attaching parts 24 and 34.

The attaching parts 24 and 34 are constructed so that respective hand parts 23 and 33 are attachable thereto and detachable therefrom. For example, each of the attaching parts 24 and 34 has a pair of bar members which are constructed to be adjustable of an interval therebetween. The attaching parts 24 and 34 can attach the respective hand parts 23 and 33 to the respective wrist parts 22 and 32 by pinching the respective hand parts 23 and 33 by the respective pairs of bar members. Thus, each of the hand parts 23 and 33 is rotatable about a rotation axis L3 by the rotary joint J4. Note that tip-end portions of the bar members may be bent or curved.

The first hand part 23 is provided to a tip end of the first arm 20, and is comprised of a flat-plate part 25 and a depressing part 26 detachably attached by the first attaching part 24. The second hand part 33 is provided to a tip end of the second arm 30, and is comprised of a cylindrical part 35 detachably attached by the second attaching part 34. Note that the details of the first hand part 23 and the second hand part 33 will be described later.

Note that the joints J1-J4 of the first arm 20 and the second arm 30 are provided with drive motors (not illustrated) as one example of actuators which relatively rotate or ascend and descend two members coupled through the respective joints. The drive motor may be, for example, a servo motor which is servo-controlled by the control device 40. Moreover, each of the joints J1-J4 is provided with a rotation sensor (not illustrated) which detects a rotational position of the drive motor, and a current sensor (not illustrated) which detects current for controlling rotation of the drive motor. The rotation sensor may be, for example, an encoder.

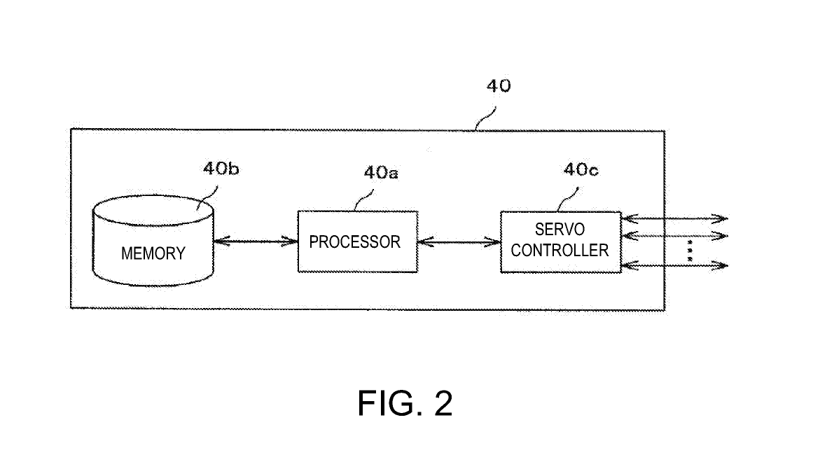

Next, the control device 40 is described with reference to FIG. 2. The control device 40 is a robot controller provided with, for example, a computer, such as a microcontroller, which includes a processor 40a, such as a CPU, a memory 40b, such as a ROM and/or RAM, and a servo controller 40c. Note that the control device 40 may be comprised of a sole control device 40 which carries out a centralized control, or may be comprised of a plurality of control devices 40 which collaboratively carry out a distributed control. Moreover, although the memory 40b is disposed inside the control device 40, it is not limited to this structure, and the memory 40b may be provided separately from the control device 40.

The memory 40b stores information on a basic program as the robot controller, various fixed data, etc. The processor 40a controls various operations of the robot 100 by reading and executing software, such as the basic program stored in the memory 40b. That is, the processor 40a generates a control command of the robot 100, and outputs it to the servo controller 40c. The servo controller 40c controls the drive of the servo motors corresponding to the joints J1-J4 of each of the arms 20 and 30 of the robot 100 based on the control command generated by the processor 40a. For example, the control device 40 operates the first arm 20 and the second arm 30 so as to move the cylindrical part 35 and the flat-plate part 25 above the container, while the flat-plate part 25 covering the bottom opening of the cylindrical part 35 in which food is accommodated.

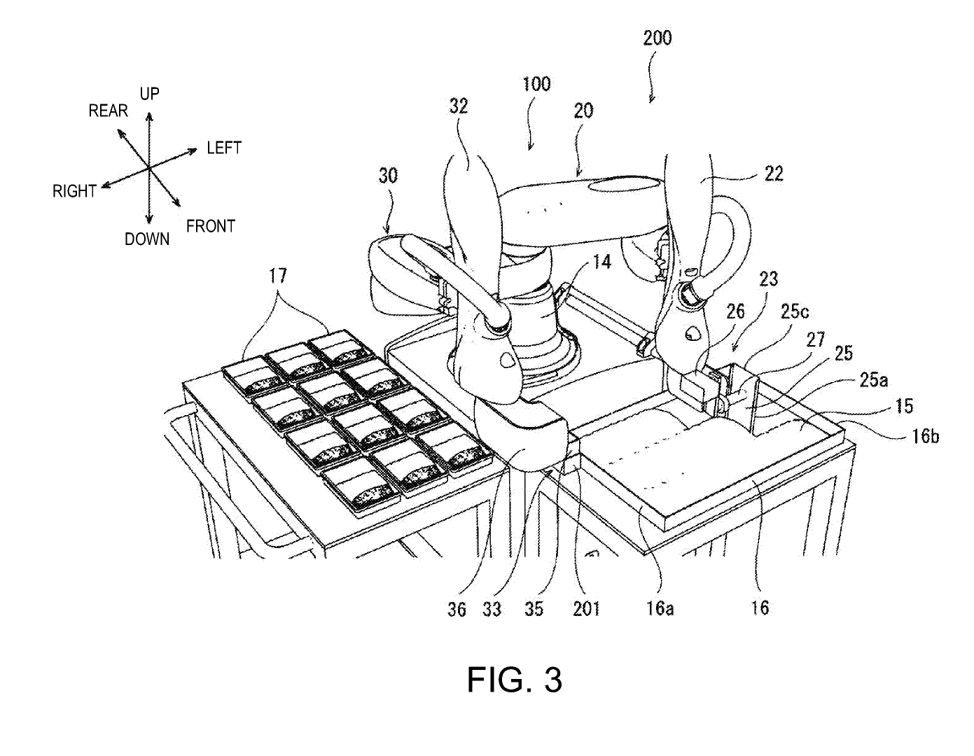

Next, the first hand part 23 of the first arm 20 is described with reference to FIGS. 3 to 9. The first hand part 23 is comprised of the flat-plate part 25 and the depressing part 26, and the second hand part 33 is comprised of the cylindrical part 35 having a top opening and the bottom opening.

The flat-plate part 25 is a thin plate-shaped body, and is, for example, a rectangular flat plate. The flat-plate part 25 is attached to the first wrist part 22 through a first fixture 27. The first fixture 27 is provided with a driving part (not illustrated), such as an actuator, and by this driving part, the first fixture 27 is rotated centering on a rotation axis perpendicular to the axis of the first wrist part 22 extending in the up-and-down direction. Note that the flat-plate part 25 may be bent or curved, as long as it is a plate-shaped body.

The flat-plate part 25 is connected to the first fixture 27 at a position closer to a second end 25c than a first end 25b in the longitudinal or long-side direction, and at a center of a pair of side ends in the short-side direction. The first end 25b and the second end 25c extend linearly in parallel to the rotation axis of the first fixture 27, and the pair of side ends extend perpendicular to the rotation axis of the first fixture 27. The flat-plate part 25 projects toward the first end 25b and the second end 25c from the connected position with the first fixture 27 in the longitudinal direction. For example, in the flat-plate part 25, a portion (first portion) between the connected position of the first fixture 27, and the first end 25b in the longitudinal direction is longer than a portion (second portion) between the connected position of the first fixture 27, and the second end 25c.

The flat-plate part 25 has a first principal surface to which the first fixture 27 connects, and a second principal surface which is opposite from the first principal surface. The first principal surface and the second principal surface are provided perpendicular to the first fixture 27, and take positions parallel and perpendicular to the axis of the first wrist part 22, and inclined positions between these positions, by the rotation of the first fixture 27.

Linearly-protruded parts 25a are provided to the pair of side ends of the flat-plate part 25. The linearly-protruded parts 25a extend along the respective side ends between the first end 25b and the second end 25c, and protrude from the first principal surface side. Thus, the flat-plate part 25 is not an entirely flat plate, but a part thereof may be dented or protruded. Note that the linearly-protruded part 25a may not be provided to the flat-plate part 25, and the flat-plate part 25 may be a flat plate.

The depressing part 26 has a pillar shape, and a bottom surface 26a thereof has the same shape as the top opening of the cylindrical part 35, and the size of the bottom surface 26a is the same as or a little smaller than that of the top opening of the cylindrical part 35. The depressing part 26 is attached to the first wrist part 22 through the first fixture 27. The depressing part 26 is connected to the first fixture 27 at the opposite side of the flat-plate part 25, having the rotation axis of the first fixture 27 therebetween. The depressing part 26 is disposed at the second end 25c side of the flat-plate part 25, from the rotation axis of the first fixture 27.

The depressing part 26 has a third principal surface to which the first fixture 27 connects, and a fourth principal surface (bottom surface) 26a which is opposite from the third principal surface. The bottom surface 26a is provided in parallel with the first principal surface and the second principal surface of the flat-plate part 25, and takes positions parallel or perpendicular to the axis of the first wrist part 22, and inclined positions between these positions, by the rotation of the first fixture 27.

The flat-plate part 25 and the depressing part 26 are movable in the left-and-right direction and the front-and-rear direction by the respective parts of the first arm 20 being rotated about the respective rotation axes L1, L2, and L3 (FIG. 1) by the rotary joints J1, J2, and J4 (FIG. 1). Moreover, the flat-plate part 25 and the depressing part 26 are movable in the up-and-down direction by the first wrist part 22 of the first arm 20 is raised or lowered with respect to the #1b link 21b by the linear-motion joint J3 (FIG. 1). Thus, the first arm 20 can move the flat-plate part 25 and the depressing part 26.

The cylindrical part 35 has a cylindrical shape of which the top and the bottom are opened, and for example, the top opening and the bottom opening have a rectangular shape. The size of the bottom opening of the cylindrical part 35 is the same as or smaller than that of the first portion of the flat-plate part 25. The cylindrical part 35 is attached to the second wrist part 32 through a second fixture 36.

The second fixture 36 has a substantially rectangular parallelepiped shape, and an upper surface thereof is connected to the second wrist part 32. A side surface (attaching surface) 36a of the second fixture 36 is perpendicular to the upper surface, and the cylindrical part 35 is attached to a lower part of the attaching surface 36a. The attaching surface 36a extends above the top opening of the cylindrical part 35, and is provided perpendicular to the top edge of the cylindrical part 35. A length (width) of the cylindrical part 35 extending in parallel with the attaching surface 36a is the same as or larger than the length of the first end 25b of the flat-plate part 25, and is the same as or small than the length of the second end 25c.

This cylindrical part 35 is movable in the left-and-right direction and the front-and-rear direction by the respective parts of the second arm 30 being rotated about the respective rotation axes L1, L2, and L3 (FIG. 1) by the respective rotary joints J1, J2, and J4 (FIG. 1). Moreover, the cylindrical part 35 is movable in the up-and-down direction by the second wrist part 32 of the second arm 30 being raised and lowered with respect to the #2b link 31b by the linear-motion joint J3 (FIG. 1). Thus, the second arm 30 can move the cylindrical part 35.

### [Configuration of Dish-Up System]

Next, a configuration of a dish-up system 200 is described with reference to FIGS. 3 to 9. The dish-up system 200 is comprised of the robot 100 and a placing surface 201a. The placing surface 201a is a surface on which the cylindrical part 35 is placed, and for example, is an upper surface of a placing part 201. The placing part 201 has a rectangular parallelepiped shape, and is disposed along a first side wall 16a of a container 16 which accommodates food 15. The area of the placing surface 201a is the same as or larger than that of the bottom opening of the cylindrical part 35, and the placing surface 201a closes the bottom opening of the cylindrical part 35 placed thereon. The height of the placing part 201 is set so that the top edge of the cylindrical part 35 placed on the placing surface 201a is located above the top edge of the container 16. The top opening of the cylindrical part 35 placed on the placing surface 201a is adjacent to the opening of the container 106.

For example, the container 16 is disposed in front of the robot 100, a container 17 is disposed on the right side of the robot 100, and the placing part 201 is disposed between the container 16 and the container 17. The container 17 may be disposed on a movable bench. For example, a plurality of robots 100 are provided to the dish-up system 200, and each robot 100 dishes up a different food 15. In this case, the plurality of robots 100 can dish up the respective foods 15 to the container 17 by sequentially moving the bench to the order of the plurality of robots 100.

### [Method of Operating Robot]

Next, the method of operating the robot 100 according to Embodiment 1 is described with reference to FIGS. 3 to 9. This operating method is implemented by the control device 40. Here, a case where cooked rice (food) 15 accommodated in the container 16 is dished up in the container 17 (lunch box) is described.

Note that the container 17 is not limited to the lunch box, as long as the upper surface thereof is opened. The food 15 is not limited to the cooked rice, as long as it is solid food.

First, as illustrated in FIG. 3, the control device 40 operates the first arm 20 so that the food 15 accommodated in the container 16 is brought to one side by the flat-plate part 25. Here, the first principal surface of the flat-plate part 25 is inclined to become perpendicular or substantially perpendicular to the bottom surface 26a of the container 16 so that the first end 25b of the flat-plate part 25 becomes below the second end 25c. Then, the first end 25b is brought in contact with the bottom of the container 16, and the flat-plate part 25 is moved toward the first side wall 16a of the container 16 from a second side wall 16b side which is located opposite of the first side wall 16a. Thus, the food 15 is brought to the first side wall 16a side of the container 16 adjacent to the placing part 201. In addition, by bringing the food 15 to one side in this way, the thickness and density of the food 15 accommodated in the container 16 become uniform.

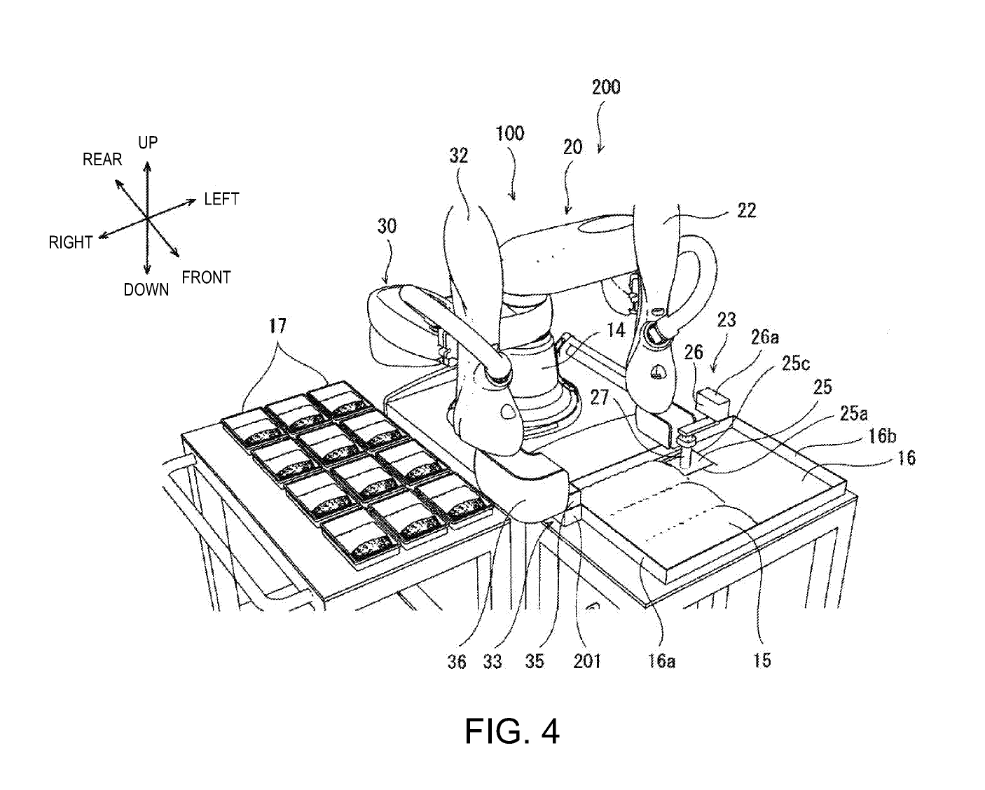

Next, as illustrated in FIG. 4, the control device 40 operates the first arm 20 so that the food 15 accommodated in the container 16 is scooped up by the flat-plate part 25, and is inserted through the top opening into the cylindrical part 35 placed on the placing surface 201a. Here, the flat-plate part 25 is moved above the food 15, the first principal surface of the flat-plate part 25 is made above the second principal surface, and the first principal surface is inclined parallel or substantially parallel to the bottom surface 26a of the container 16. Then, the flat-plate part 25 is moved toward the second side wall 16b of the container 16 from the food 15, and the flat-plate part 25 is moved to the first side wall 16a side from the second side wall 16b side, while bringing the first end 25b of the flat-plate part 25 in contact with the bottom surface 26a of the container 16. Thus, the food 15 is placed on the first principal surface of the first portion of the flat-plate part 25. Then, the flat-plate part 25 is moved above the food 15, after it is moved by a given distance. Thus, a given amount of the food 15 is taken out by the flat-plate part 25.

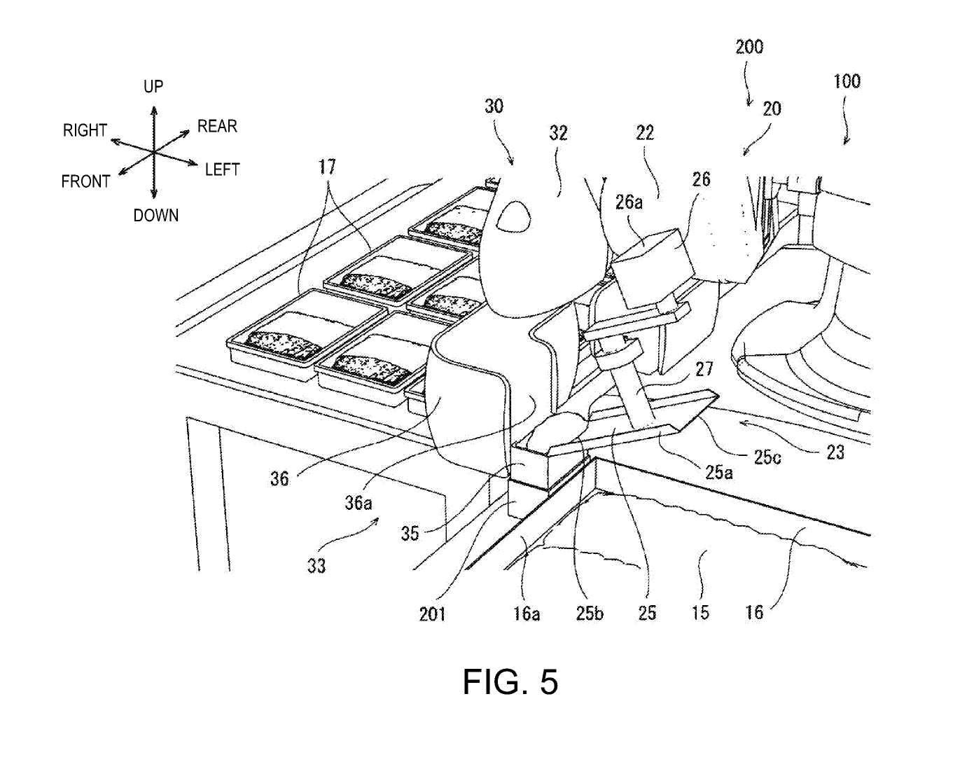

Moreover, as illustrated in FIG. 5, the flat-plate part 25 where the food 15 is placed on the first principal surface is moved to the cylindrical part 35, the first end 25b of the flat-plate part 25 is brought in contact with the top edge of the cylindrical part 35, and the flat-plate part 25 is inclined so that the second end 25c of the flat-plate part 25 becomes above the first end 25b. Thus, the food 15 slides down the first inclining principal surface, and enters into the cylindrical part 35 through the top opening of the cylindrical part 35. Moreover, at this time, since the linearly-protruded parts 25a are projected upwardly from the pair of side ends of the first principal surface, it can prevent that the food 15 falls outside from the pair of side ends.

Further, the food 15 which slides down the flat-plate part 25 may go beyond the top opening of the cylindrical part 35. In this case, the food 15 hits the attaching surface 36a of the second fixture 36 provided perpendicular to the top edge of the cylindrical part 35, and then falls into the top opening of the cylindrical part 35 provided therebelow. Therefore, the food 15 enters into the cylindrical part 35.

Moreover, since the length of the first end 25b of the flat-plate part 25 is the same as or shorter than the width of the cylindrical part 35, the first end 25b does not protrude from the cylindrical part 35 in the width direction. Therefore, the food 15 does not fall outside of the cylindrical body through a gap between the first end 25b and the cylindrical part 35.

Further, the cylindrical part 35 is placed on the placing surface 201a, and the bottom opening of the cylindrical part 35 is covered by the placing surface 201a. Therefore, the food 15 is accommodated in the cylindrical part 35.

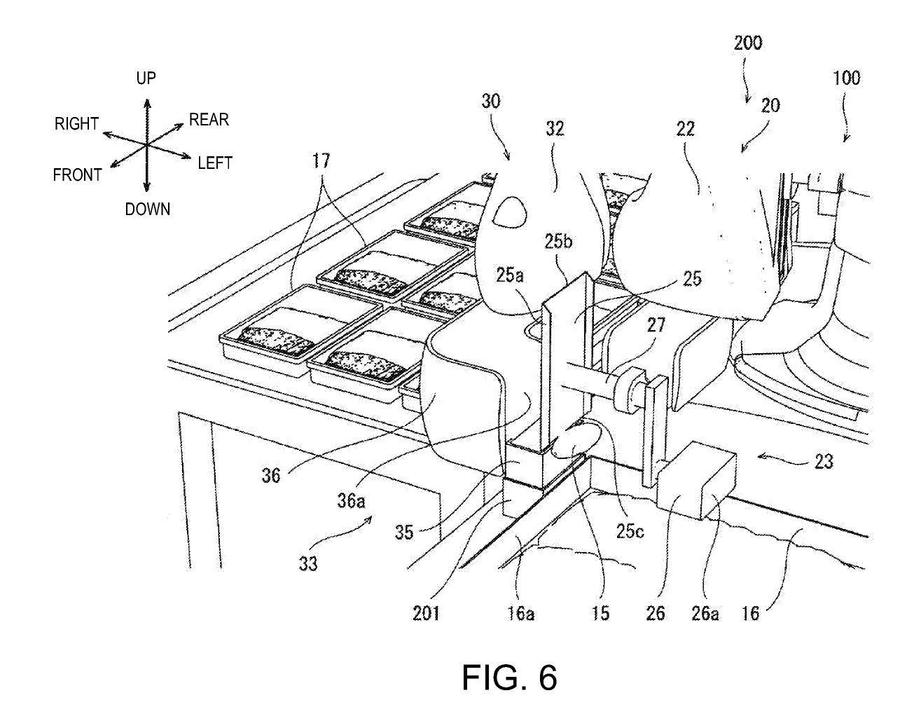

Then, as illustrated in FIG. 6, the control device 40 operates the first arm 20 so that the second end 25c (one end) of the flat-plate part 25 is brought in contact with the top edge of the cylindrical part 35 which accommodates the food 15 and is then slid thereon to remove the food 15 above the top edge.

Here, the second end 25c of the flat-plate part 25 is below the first end 25b, and the first principal surface of the flat-plate part 25 is inclined perpendicular or substantially perpendicular to the bottom surface 26a of the container 16. Then, the second end 25c is brought in contact with the top edge of the cylindrical part 35, and the flat-plate part 25 is moved to the container 16 side from the second fixture 36 side. The top opening of the cylindrical part 35 is above the opening of the container 16, and is adjacent to the opening of the container 16. Thus, the food 15 above the top edge is removed by the flat-plate part 25, and falls onto the container 16. Therefore, the given amount of the food 15 can be left inside the cylindrical part 35.

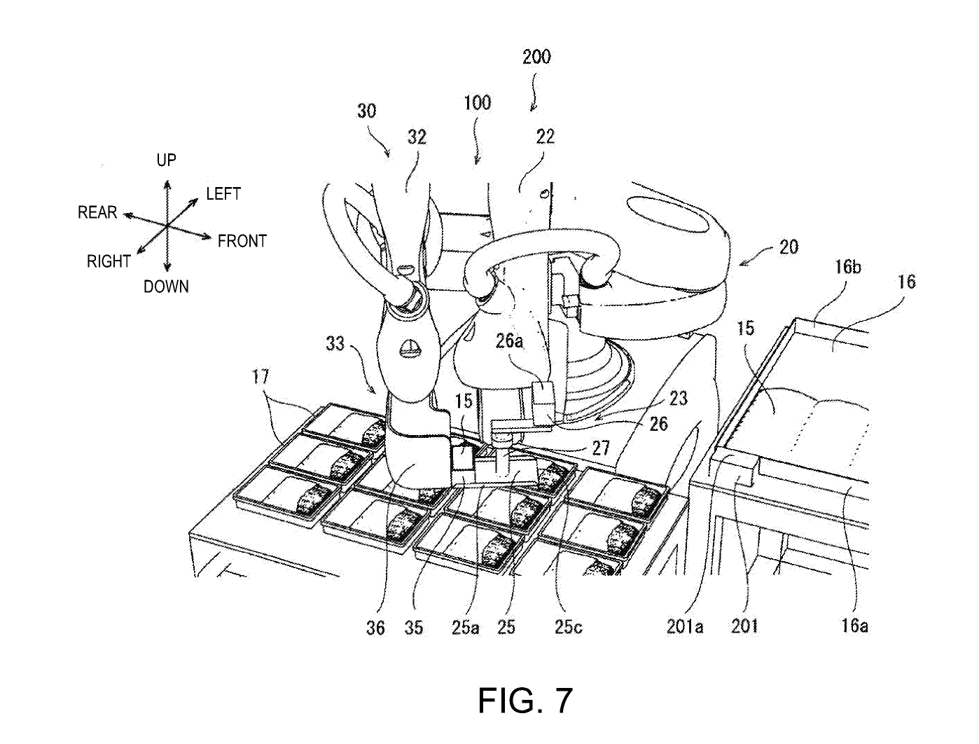

Then, as illustrated in FIG. 7, the control device 40 operates the first arm 20 and the second arm 30 so that the cylindrical part 35 and the flat-plate part 25 are moved to a location above the container 17, while covering by the flat-plate part 25 the bottom opening of the cylindrical part 35 which accommodates the food 15. Here, first, the first principal surface of the flat-plate part 25 is made horizontal above the second principal surface, and the flat-plate part 25 is inserted into a space between the placing surface 201a of the placing part 201 and the bottom edge of the cylindrical part 35. Thus, the bottom opening of the cylindrical part 35 is covered by the flat-plate part 25, and the flat-plate part 25 functions as the bottom of the cylindrical part 35. Then, while the bottom opening is covered by the flat-plate part 25, the cylindrical part 35 and the flat-plate part 25 are moved above the container 17. Thus, the food 15 is carried above the container 17.

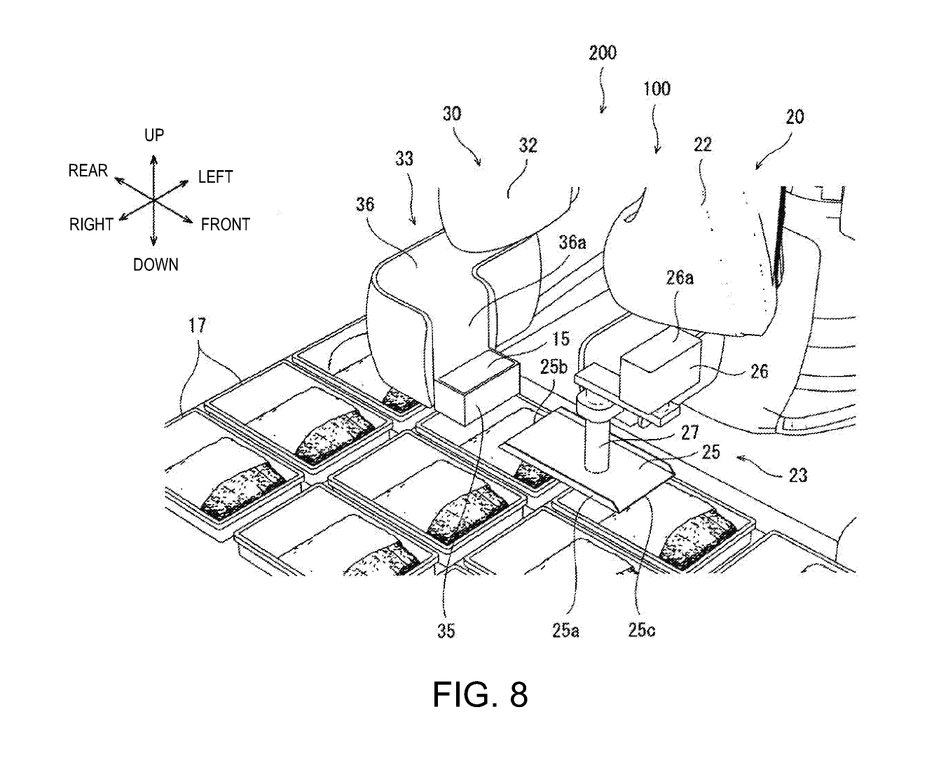

Then, as illustrated in FIG. 8, the control device 40 operates the first arm 20 so that the flat-plate part 25 is moved above the container 17 to open the bottom opening of the cylindrical part 35. Here, when the cylindrical part 35 reaches above a desired position inside the container 17, the flat-plate part 25 is moved horizontally along the bottom edge of the cylindrical part 35 to separate the flat-plate part 25 from the cylindrical part 35. Thus, the bottom opening of the cylindrical part 35 covered by the flat-plate part 25 is opened. Thus, by the flat-plate part 25 sliding along the bottom edge of the cylindrical part 35, the interval between the cylindrical part 35 and the container 17 can be reduced.

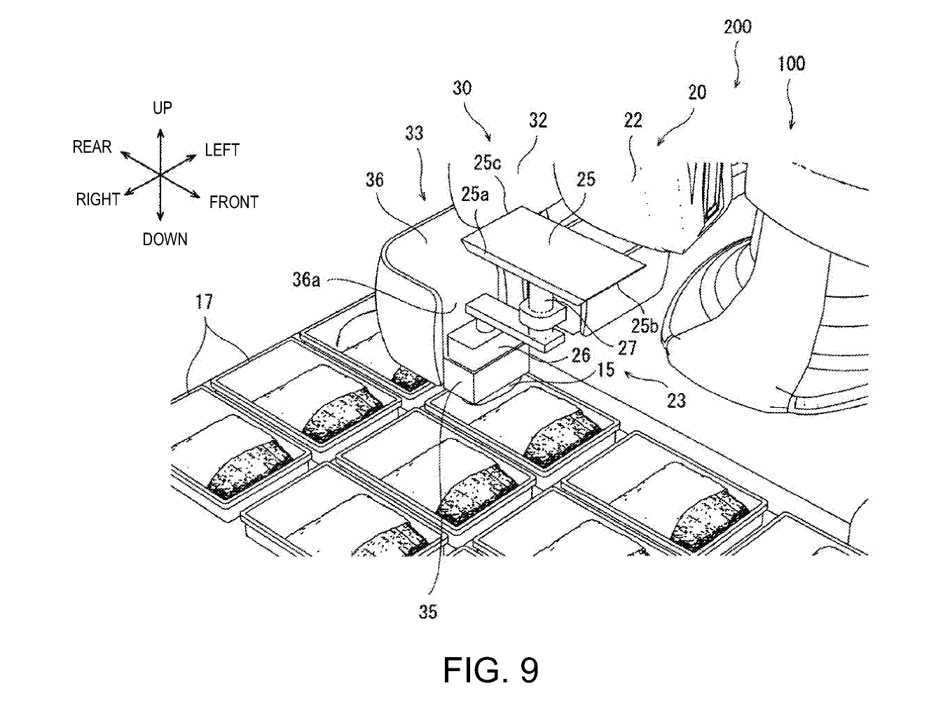

Then, as illustrated in FIG. 9, the control device 40 operates the first arm 20 so that the food 15 accommodated in the cylindrical part 35 is depressed by the depressing part 26. Here, by rotating the first fixture 27, the depressing part 26 is made below the flat-plate part 25, and the bottom surface 26a of the depressing part 26 is made horizontal. Then, the depressing part 26 is moved above the top opening of the cylindrical part 35, and the depressing part 26 is then moved downwardly. Thus, the food 15 inside the cylindrical part 35 is pushed downwardly by the bottom surface 26a of the depressing part 26, and falls to be dished up at the desired position in the container 17. Thus, the food 15 can be inserted into the container 17 from a short distance. Moreover, the food 15 which does not fall only by opening the bottom opening can also be dropped by the depressing part 26, and can be certainly inserted into the container 17.

According to the above configuration, by closing the bottom opening of the cylindrical part 35 by the flat-plate part 25, the flat-plate part 25 can be slid from the cylindrical part 35 above the container 17 to open the bottom opening. Thus, since the flat-plate part 25 hardly moves toward the container 17, the cylindrical part 35 can be brought closer to the container 17. Therefore, the food 15 can be dropped from the cylindrical part 35 located closer thereto to be dished up at the desirable position in the container 17.

Moreover, by moving the flat-plate part 25 with respect to the cylindrical part 35, the bottom opening of the cylindrical part 35 can be closed and opened. Therefore, a mechanism for closing and opening the bottom opening is not necessary to be provided to the flat-plate part 25 and the cylindrical part 35, and the food 15 is not built up at such a mechanism. In addition, since the flat-plate part 25 and the cylindrical part 35 become simpler and it is easy to clean them, these parts can be kept sanitary.

Further, the flat-plate part 25 can be functioned as a tool which brings the food 15 to one side, a tool which scoops up the food 15, a tool which inserts the food 15 into the cylindrical part 35, a tool which removes the food 15 jutted out of the cylindrical part 35, and a tool which closes the bottom opening of the cylindrical part 35. Therefore, this leads to a reduction of the number of components and the cost.

### Embodiment 2

A robot 100 according to Embodiment 2 further includes a grip part 37 provided to the second arm 30, and a to-be-gripped part 38 provided to the cylindrical part 35. Moreover, in the robot 100 according to Embodiment 2, the depressing part 26 is not provided to the first hand.

The to-be-gripped part 38 is provided onto a base plate 39 extending from the top edge of the cylindrical part 35 to the opposite side of the top opening, and projects upwardly from the base plate 39. The grip part 37 detachably grips the cylindrical part 35, and for example has a pair of bar members. The pair of bar members are driven by a driving part (not illustrated), such as an actuator, so that a mutual interval is changed. The grip part 37 narrows the interval between the pair of bar members to pinch the to-be-gripped part 38, and expands the interval between the pair of bar members to release the to-be-gripped part 38. Note that, sides of the pinching parts where the pair of pinching parts oppose to each other may be curved along the surface of the to-be-gripped part 38 so that the sides contact the to-be-gripped part 38.

The control device 40 operates the second arm 30 so that the grip part 37 grips the to-be-gripped part 38 and moves the cylindrical part 35. Moreover, by the depressing part 26 not being provided to the first arm 20, the operation by the depressing part 26 which pushes down the food 15 inside the cylinder can be omitted. Since other methods of operating the robot 100 are similar to those of Embodiment 1, the description is omitted.

Thus, the cylindrical part 35 can be detachably attached to the second arm part 31 by the grip part 37 and the to-be-gripped part 38. Therefore, for example, a plurality of cylindrical parts 35 having different sizes, shapes, etc. are prepared, and one cylindrical part 35 according to the kind, size, etc. of the food 15 can be attached to the second arm 30.

### Other Embodiments

Note that, although in Embodiment 1 the first hand is provided with the flat-plate part 25 and the depressing part 26, the first hand may only be provided with the flat-plate part 25, without being provided with depressing part 26. For example, if the food 15 has a less adhesion characteristic to the cylindrical part 35, the food 15 may fall from the cylindrical part 35 only by sliding the flat-plate part 25 covering the bottom opening of the cylindrical part 35 to open the bottom opening. In such a case, since there is no necessity to push down the food 15 inside the cylindrical part 35 by the depressing part 26, the depressing part 26 can be omitted and the cost, and the time and effort of the dish-up work can be reduced.

Further, a plurality of cylindrical parts 35 having different sizes, shapes, etc. may be attached to the second fixture 36 in Embodiment 1. In this case, by rotating the second fixture 36 by the rotary joint J4, one cylindrical part 35 according to the kind, size, etc. of the food 15 can be selectively used.

Moreover, although the first hand is not provided with the depressing part 26 in Embodiment 2, it may be provided. For example, if the food 15 has a more adhesion characteristic to the cylindrical part 35, the food 15 may not fall from the cylindrical part 35 only by opening the bottom opening of the cylindrical part 35. In such a case, by depressing the food 15 inside the cylindrical part 35 by the depressing part 26, the food 15 can be dropped and dished up in the container 17.

Further, in all of the above embodiments, the robot 100 performs the processing to bring the food 15 to one side, the processing to scoop up the food 15, the processing to insert the food 15 into the cylindrical part 35, the processing to remove the food 15 jutted out of the cylindrical part 35, the processing to close the bottom opening of the cylindrical part 35 by the flat-plate part 25 and to move the food 15, the processing to separate the flat-plate part 25 from the cylindrical part 35 to open the bottom opening, and the processing to depress the food 15 by the depressing part 26. However, it is not necessary to perform all of these processings, and some of the processing may be omitted. Moreover, in addition to these processings, other processings may be performed.

It is apparent for a person skilled in the art that many improvements or other embodiments of the present disclosure are possible from the above description. Therefore, the above description is to be interpreted only as illustration, and it is provided in order to teach a person skilled in the art the best mode to implement the present disclosure. The details of the structure and/or the functions may be changed substantially, without departing from the spirit of the present disclosure.

### INDUSTRIAL APPLICABILITY

The robot and method of operating the same of the present disclosure are useful for, for example, the sanitary robot and the method of operating the same which can dish up the food at the desired position.

### DESCRIPTION OF REFERENCE CHARACTERS

15: Food
17: Container
18: Container
20: First Arm
25: Flat-plate Part (Plate-shaped Part)
26: Depressing Part
30: Second Arm
35: Cylindrical Part
37: Grip Part
38: To-be-gripped Part
40: Control Device
100: Robot
201a: Placing Surface

1. A robot configured to pack food in a container, comprising:
a first arm configured to move a plate-shaped part;
a second arm configured to move a cylindrical part having a top opening and a bottom opening; and
a control device,
wherein the control device operates the first arm and the second arm so that the cylindrical part and the plate-shaped part are moved above the container, while covering by the plate-shaped part the bottom opening of the cylindrical part where the food is accommodated, and the plate-shaped part is moved over the container to open the bottom opening.

2. The robot of claim 1, wherein the control device operates the first arm so that the food accommodated in the container is brought to one side by the plate-shaped part.

3. The robot of claim 1, wherein the control device operates the first arm so that the food accommodated in the container is scooped up by the plate-shaped part and is inserted through the top opening into the cylindrical part placed on a placing surface.

4. The robot of claim 1, wherein the control device operates the first arm so that one end of the plate-shaped part is brought in contact with a top edge of the cylindrical part where the food is accommodated and is slid on the top edge to remove the food above the top edge.

5. The robot of claim 1, further comprising a depressing part provided to the first arm,
wherein the control device operates the first arm so that the food accommodated in the cylindrical part of which the bottom opening is opened is depressed by the depressing part.

6. The robot of claim 1, further comprising:
a grip part provided to the second arm; and
a to-be-gripped part provided to the cylindrical part,
wherein the control device operates the second arm so that the cylindrical part is moved by the grip part gripping the to-be-gripped part.

7. A method of operating a robot configured to pack food in a container, the robot comprising:
a first arm configured to move a plate-shaped part;
a second arm configured to move a cylindrical part having a top opening and a bottom opening; and
a control device,
wherein the control device operates the first arm and the second arm so that the cylindrical part and the plate-shaped part are moved above the container, while covering by the plate-shaped part the bottom opening of the cylindrical part where the food is accommodated, and the plate-shaped part is moved over the container to open the bottom opening.
